(19) United States
(12) Patent Application Publication
(10) Pub. No.: US 2026/0322187 A1
(43) Pub. Date: Oct. 15, 2026

(54) SLOTLESS BRUSHLESS MOTOR STATOR AND BRUSHLESS SLOTLESS MOTOR

(71) Applicant: SINO DYNAMICS (SHENZHEN) CO., LTD., Shenzhen City (CN)

(72) Inventor: HE MA, Shenzhen City (CN)

(73) Assignee: SINO DYNAMICS (SHENZHEN) CO., LTD., Shenzhen City (CN)

(21) Appl. No.: 19/693,442

(22) Filed: May 30, 2026

Related U.S. Application Data
(63) Continuation of application No. PCT/CN2026/074036, filed on Jan. 21, 2026.

(30) Foreign Application Priority Data
Mar. 11, 2025 (CN) 202510295301.X

(51) Int. Cl. H02K 1/14; H02K 3/28; H02K 3/47

(52) U.S. Cl. CPC H02K 1/14; H02K 3/28; H02K 3/47

(57) ABSTRACT

Disclosed are a slotless brushless motor stator and a brushless slotless motor. The slotless brushless motor stator includes multiple coil structures, which are arranged around circumference direction to form a cylindrical structure. Each coil structure includes an insulating substrate and multiple layers of coils. Each layer coil has a first connection end and a second connection end. Each layer coil is arranged in a spiral shape, with the first connection end being the outer end of the coil and the second connection end being the inner end of the coil. The first connection end of the first layer coil is set as the positive terminal or negative terminal of the coil structure, and the second connection end of the outermost layer coil is set as the negative terminal or positive terminal. It aims to achieve miniaturization or even miniaturization design of motors.

### CROSS-REFERENCE

This application is a continuation of International Application No. PCT/CN2026/074036 with a filling date of Jan. 21, 2026, designating the United States, now pending, which further claims to the benefit of priority from Chinese Application No. 202510295301.X with a filing date of Mar. 11, 2025. The content of the aforementioned applications, including any intervening amendments thereto, are incorporated herein by reference.

### TECHNICAL FIELD

The present disclosure relates to the technical field of motor, in particular to a slotless brushless motor stator and a brushless slotless motor.

### BACKGROUND

Brushless slotless motor is a type of motor that uses electronic commutation technology, compared to traditional brushed motors, it has higher efficiency, longer service life, and lower noise. With the development and updating of technology, the demand for small motors and even micro motors is constantly increasing in many industries, and the requirement for the miniaturization, even micro-miniaturization, of brushless slotless motor designs are becoming increasingly stringent.

In traditional brushless slotless motors, the stator winding is formed by winding copper or aluminum wires. Due to the volume limitations of copper or aluminum wires and the limitations of winding processes, the miniaturization design of traditional brushless slotless motors has reached its limit.

### SUMMARY

The objective of the present disclosure is to provide a slotless brushless motor stator and a brushless slotless motor, aiming to solve the problem of miniaturization or even miniaturization design of brushless slotless motors in related technologies.

To achieve the above objective, according to the first aspect of the present disclosure, the technical solution adopted by the present disclosure is: a slotless brushless motor stator, including a plurality of coil structures arranged along circumference to form a cylindrical structure;

Each coil structure comprises an insulating substrate and multiple layers of coils stacked on the insulating substrate, each coil structure comprises n layers of coils, and n≥2m, where m is a positive integer, at least one wire arranged in a spiral shape to form each layer of the coils, and each layer of the coils includes a first connection end and a second connection end.

The first connection end is a spiral outer end of each layer of the coils, and the second connection end is a spiral inner end of each layer of the coils, and spiral directions of two adjacent layers of the coils from the first connection end to the second connection end are opposite.

In the radial direction outward along the axis of the cylindrical structure, the first connection end of a first layer of the coils is set as one of a positive terminal and a negative terminal of each coil structure, and the first connection end or the second connection end of an outermost layer of the coils is set as another of the positive terminal and the negative terminal of each coil structure; between two adjacent layers of the coils, two of the first connection ends or two of the second connection ends are electrically connected, so that the multiple layers of the coils are arranged in series, and an insulation layer is provided between two adjacent layers of the coils.

Each coil structure of the slotless brushless motor stator provided in the embodiments of the present disclosure includes an insulating substrate and multiple layers of coils stacked on the insulating substrate, such that each coil structure is formed into a sheet-like structure, greatly reducing the overall thickness of the coil structure. The coil structure of the slotless brushless motor stator in the present disclosure adopts a design structure in which multiple layers of coils are stacked and laid on the insulating substrate. The winding path of each layer of coils is arranged in a spiral pattern. Compared with traditional stator winding, the wiring of the coil of the slotless brushless motor stator in the present disclosure can be laid and arranged more evenly and regularly, thereby reducing the space waste generated during the laying process of the coil. When multiple coil structures are arranged in a cylindrical shape along the circumference, and in the case where the volume of the slotless brushless motor stator of the present disclosure is equal to that of the traditional stator winding, the winding path of the coil of the slotless brushless motor stator of the present disclosure can be laid out more evenly and regularly. Therefore, the slotless brushless motor stator of the present disclosure can lay more turns of coils, that is, the slot fill factor of the coil in the slotless brushless motor stator of the present disclosure is higher (slot fill factor is an important parameter in motor design, and a higher slot fill factor can increase the power density and efficiency of motor), thereby enhancing the electromagnetic induction intensity, which is conducive to improving the output power and torque of the brushless slotless motor using the slotless brushless motor stator. In other words, when the number of turns of the slotless brushless motor stator of the present disclosure is equal to that of the traditional stator winding, the slotless brushless motor stator of the present disclosure greatly reduces the overall volume of the cylindrical structure, such that the volume of the stator of the brushless slotless motor using the slotless brushless motor stator is greatly reduced, thus greatly reducing the overall volume of the brushless slotless motor, thereby achieving the goal of further miniaturization or even miniaturization design of the brushless slotless motor. Moreover, compared to traditional stator winding, the design structure of the coil of the slotless brushless motor stator in the present disclosure is structured to be compatible with industrialized, high-volume manufacturing processes.

In some embodiments of the present disclosure, in each coil structure, along the radial direction of the cylindrical structure, the projections of the first connection end and the second connection end of each layer of the coils on the insulating substrate coincide.

In some embodiments of the present disclosure, at least one wire of each layer of the coils is prepared and formed through additive manufacturing, and the cross-section of at least one wire is rectangular, trapezoidal, or curved at the top (similar to a bread cross-section).

In some embodiments of the present disclosure, along the axial direction of the cylindrical structure, the shape of each layer of the coils is rectangle, rhombus, polygon, rounded rectangle, or olive-shaped.

In some embodiments of the present disclosure, at least one wire of each layer of the coils has a variable width in the wiring direction, and in the same coil structure, the number of turns of any two layers of the coils is equal or unequal.

In some embodiments of the present disclosure, when the shape of each coil in each layer of the coils is rounded rectangle, the insulating substrate is square, at least one wire that forms each layer of the coils includes multiple straight sections along the length direction of the insulating substrate and multiple variable diameter sections located at both ends of the insulating substrate. The lengths of the multiple straight sections are equal, and the wire width of the straight sections is greater than, equal to, or less than the wire width of the variable diameter sections.

In some embodiments of the present disclosure, in the same coil structure, the wire thickness of at least one wire in any two layers of the coils is equal or unequal.

In some embodiments of the present disclosure, the wire thickness of the multiple layers of coils of each coil structure gradually increases radially outward along the axis of the cylindrical structure.

In some embodiments of the present disclosure, the slotless brushless motor stator further includes an iron core tube. The iron core tube is fixed outside the cylindrical structure and is formed by stacking a plurality of ring-shaped magnetic material sheets.

In some embodiments of the present disclosure, the cylindrical structure consists of multiple layers of cylinders arranged in sequence, with an equal number of coil structures in each layer. Along the radial direction of the cylindrical structure, multiple coil structures between two adjacent layers of cylinders are arranged in a one-to-one correspondence and face each other directly, or multiple coil structures between any two adjacent layers of cylinders are circumferentially offset by a predetermined angle in the same direction.

In some embodiments of the present disclosure, the coil structure is provided with stepped edges. Along the radial direction of the cylindrical structure, the stepped edges form a first coil portion and a second coil portion with a height difference, and the height of the stepped edges is equal to the thickness of the coil structure. In two adjacent coil structures along the circumference of the cylindrical structure, the first coil portion of one coil structure is stacked with the second coil portion of the other coil structure, and multiple coil structures are connected end-to-end to form a cylindrical structure.

According to the second aspect of the present disclosure, there is provided a brushless slotless motor, which includes the following components:
A shell with assembly space;
A slotless brushless motor stator mentioned above, wherein the slotless brushless motor stator is accommodated in the assembly space;
Two bearings installed on the shell, which are located at both ends of the slotless brushless motor stator;
A rotor assembly, which is rotatably installed in the slotless brushless motor stator, and the two ends of the rotor assembly are respectively mounted on the two bearings.

### BRIEF DESCRIPTION OF THE DRAWINGS

In order to provide a clearer illustration of the technical solution in the embodiments of the present disclosure, a brief introduction will be given to the accompanying drawings required for the embodiments or prior art description. It is obvious that the accompanying drawings described below are only some embodiments of the present disclosure. For those skilled in the art, other drawings can be obtained based on these drawings without creative labor.

FIG. 1 is a schematic diagram of the three-dimensional structure of a slotless brushless motor stator according to an embodiment of the present disclosure;

FIG. 2 is a schematic top view of the slotless brushless motor stator shown in FIG. 1 along its axial direction;

FIG. 3 is a three-dimensional schematic diagram of the cylindrical structure of the slotless brushless motor stator shown in FIG. 1;

FIG. 4 is a schematic top view of the cylindrical structure shown in FIG. 3 along its axial direction;

FIG. 5 is a schematic diagram showing one layer of the coil of the coil structure of the slotless brushless motor stator shown in FIG. 1;

FIG. 6 is a first three-dimensional schematic diagram of the coil structure of the slotless brushless motor stator shown in FIG. 1;

FIG. 7 is a second schematic diagram of the three-dimensional structure of the coil structure of the slotless brushless motor stator shown in FIG. 1;

FIG. 8 is a schematic diagram of the three-dimensional structure of another slotless brushless motor stator according to an embodiment of the present disclosure;

FIG. 9 is a schematic top view of the slotless brushless motor stator shown in FIG. 8 along its axial direction;

FIG. 10 is a first schematic diagram of the three-dimensional structure of the brushless slotless motor in the embodiment of the present disclosure;

FIG. 11 is a second schematic diagram of the three-dimensional structure of the brushless slotless motor shown in FIG. 10;

FIG. 12 is a schematic front view of the brushless slotless motor shown in FIG. 10;

FIG. 13 is an exploded schematic diagram of the brushless slotless motor shown in FIG. 10;

FIG. 14 is an exploded schematic diagram of the brushless slotless motor shown in FIG. 11;

FIG. 15 is a schematic cross-sectional view taken along the A-A direction in FIG. 12;

FIG. 16 is a schematic cross-sectional view of the coil, taking a four-layer coil as example;

FIG. 17 is a schematic cross-sectional view show that the spiral directions of two adjacent layers of the coils from the first connection end to the second connection end are opposite (See arrows of the direction from the first connection end to the second connection end).

The reference numbers labeled in the figures are shown as below:
100. slotless brushless motor stator;
10. cylindrical structure; 11. inner cylinder; 12. outer cylinder; 13. connection part;
20. coil structure; 21. insulating substrate; 22. coil; 221. first connection end; 222. second connection end; 223. straight section; 224. variable diameter section; 23. stepped edge; 24. first coil portion; 25. second coil portion;
30. iron core tube; 31. magnetic material sheet;
41. positive electrode pad; 42. negative electrode pad;
200. brushless slotless motor;
210. shell; 211. shell body; 212. end cover; 213. assembly space; 214. outlet;
220. bearing;
230. rotor assembly; 231. core shaft; 232. permanent magnet;
240. insulation layer.

### DETAILED DESCRIPTION OF THE EMBODIMENTS

The embodiments of the present disclosure are described in detail below, and examples of the embodiments are shown in the accompanying drawings, where identical or similar reference numerals from beginning to end represent identical or similar elements or elements with identical or similar functions. The embodiments described below with reference to the accompanying drawings are exemplary and intended to illustrate the present disclosure, and should not be regarded as limitations to the present disclosure.

In the description of the present disclosure, it should be understood that the terms “length”, “width”, “up”, “down”, “front”, “back”, “left”, “right”, “vertical”, “horizontal”, “top”, “bottom”, “inside”, “outside” and other directional or positional relationships indicated are based on the directional or positional relationships shown in the accompanying drawings, only for the convenience of describing the present disclosure and simplifying the description, and do not indicate or imply that the device or component referred to must have a specific orientation, be constructed and operated in a specific orientation, and therefore cannot be understood as limitations to the present disclosure.

In addition, the terms “first”, “second”, etc. are only used for descriptive purposes and cannot be understood as indicating or implying relative importance or implying the number of technical features indicated. Thus, features limited to “first”, “second”, etc. may explicitly or implicitly include one or more of these features. In the description of the present disclosure, the meaning of “multiple” refers to two or more, unless otherwise specifically limited.

In the present disclosure, unless otherwise specified and limited, the terms “install”, “connected to”, “connected with”, “fix”, etc. should be broadly understood, for example, they may be fixed connections, detachable connections, or integrated as a whole; it may be a mechanical connection or an electrical connection; it may be directly connected or indirectly connected through an intermediate medium, and it may be a connection within two components or an interaction relationship between two components. For ordinary skilled person in the art, the specific meanings of the above terms in the present disclosure can be understood according to the specific situation.

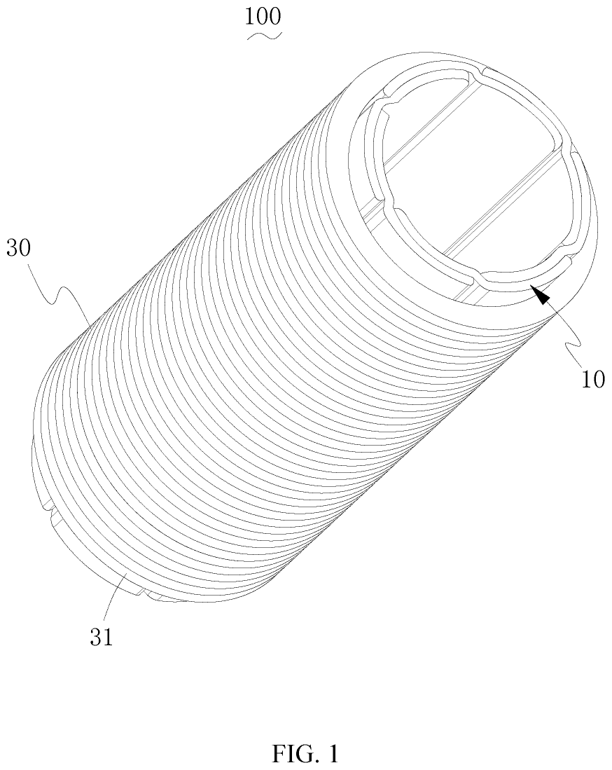

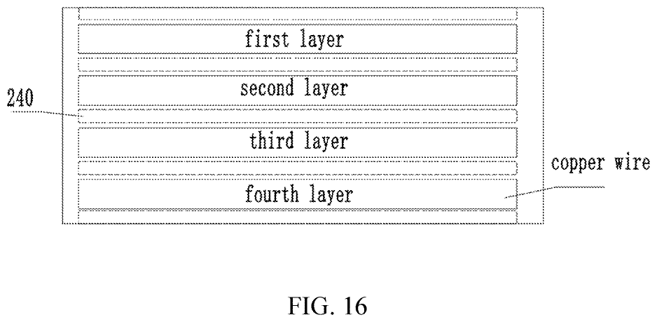

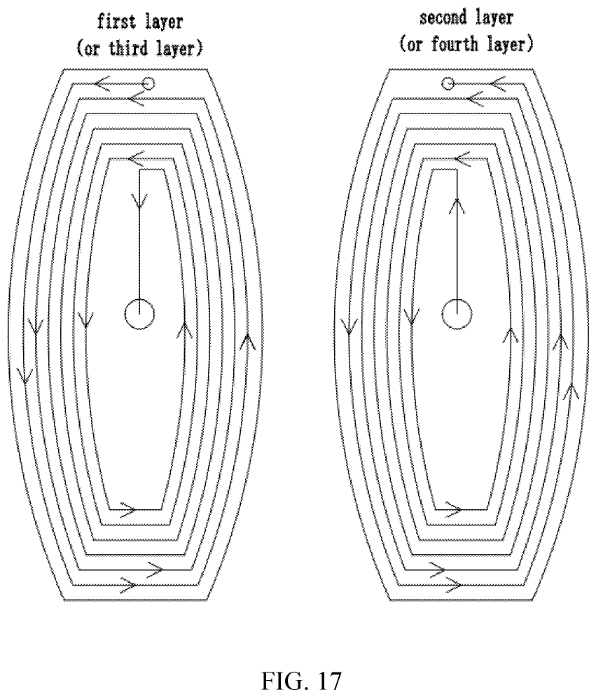

As shown in FIG. 1 to FIG. 9, the slotless brushless motor stator 100 provided by the embodiments of the disclosure includes a plurality of coil structures 20, the coil structures 20 are circumferentially arranged to form a cylindrical structure 10. Each coil structure 20 includes an insulating substrate 21 and multiple layers of coils 22 stacked on the insulating substrate 21. Each layer of coils 22 is provided with a first connection end 221 and a second connection end 222. Each layer of coils 22 is form by at least one wire arranged in a spiral. Please see FIG. 17, the first connection end 221 is the spiral outer end of the coil 22, the second connection end 222 is the spiral inner end of the coil 22, and the spiral directions of adjacent layers of coils 22 from the first connection end 221 to the second connection end 222 are opposite. In the radial direction outward from the axis of the cylindrical structure 10 of the slotless brushless motor stator 100, the first connection end 221 of the first layer of the coils 22 is set as one of the positive terminal and the negative terminal of the coil structure 20, and the first connection end 221 or the second connection end 222 of the outermost layer of the coils 22 is set as one of the positive terminal and the negative terminal of the coil structure 20. Between two adjacent layers of the coils 22, the two first connection ends 221 or the two second connection ends 222 are electrically connected, so that the multiple layers of coils 22 are arranged in series. In addition, see FIG. 16, an insulation layer is arranged between adjacent layers of the coils 22, that is, the rest of the stacking positions between adjacent layers of the coils 22 are insulated.

Each of the coil structures 20 of the slotless brushless motor stator 100 provided in the embodiments of the present disclosure include an insulating substrate 21 and multiple layers of coils 22 stacked on the insulating substrate 21, so that each of the coil structure 20 is formed into a sheet-like structure, greatly reducing the overall thickness of the coil structure 20. The coil structure 20 of the slotless brushless motor stator 100 of the present disclosure adopts a design structure in which multiple layers of coils 22 are stacked and laid on the insulating substrate 21. The wiring of each layer of coils 22 is arranged in a spiral. Compared with traditional stator winding, the wiring of the coils 22 of the slotless brushless motor stator 100 of the present disclosure can be laid and arranged more evenly and regularly, thereby reducing the space waste generated during the laying process of the coils 22. When a plurality of the coil structures 20 are circumferentially arranged to form a cylindrical structure 10, and in the case where the volume of the slotless brushless motor stator 100 of the present disclosure is equal to that of the traditional stator winding, due to the more uniform and regular arrangement of the wire of the coil 22 of the coil structures 20 of the slotless brushless motor stator 100 of the present disclosure, the slotless brushless motor stator 100 of the present disclosure can lay more turns of coils, that is, the slot fill factor of the coils of the slotless brushless motor stator 100 of the present disclosure is higher (slot fill factor is an important parameter in motor design, and a higher slot fill factor can increase the power density and efficiency of the motor), thereby enhancing the electromagnetic induction intensity and improving the output power and torque of the brushless slotless motor 200 when the slotless brushless motor stator 100 is used. In other words, when the number of turns of the slotless brushless motor stator 100 of the present disclosure is some as that of the traditional stator winding, the slotless brushless motor stator 100 of the present disclosure can greatly reduce the overall volume of the cylindrical structure 10, resulting in a significant reduction in the volume of the stator of the brushless slotless motor 200 using the slotless brushless motor stator 100. This also greatly reduces the overall volume of the brushless slotless motor 200, thereby achieving the goal of further miniaturization and even miniaturization design of the brushless slotless motor 200. Moreover, compared to traditional stator winding, the design structure of the coil 22 of the coil structure 20 of the slotless brushless motor stator 100 in this disclosure can be adapted for mass production using industrial production processes.

Among them, “each layer of coils 22 is form by at least one wire arranged in a spiral” refers to the fact that each layer of coils 22 can be formed by only one wire arranged in a spiral, or by a plurality of wires arranged in a spiral. Each layer of the coils 22 are formed by a plurality of wires arranged in a spiral, which is called a multi-strand parallel winding forming method, such as two-strand parallel winding, three-strand parallel winding and so on.

In some embodiments of the present disclosure, in each coil structure 20 of the slotless brushless motor stator 100, the projections of the first connection end 221 and the second connection end 222 of each layer of coils 22 on the insulating substrate 21 coincide radially along the cylindrical structure 10. Due to the overlapping projection of the first connection end 221 and the second connection end 222 of the multi-layer coil 22 along the radial direction of the cylindrical structure 10 on the insulating substrate 21, that is, the overlap degree of the first connection end 221 and the second connection end 222 of the multi-layer coil 22 is high, it is convenient to electrically connect the two first connection ends 221 or the two second connection ends 222 between adjacent layers of the coils 22 when forming each layer of coils 22 on the insulating substrate 21. Further, along the radial direction of the cylindrical structure 10, all the projections of the coils of each layer of coils 22 on the insulating substrate 21 overlap. When forming the each layer of coils 22, the each layer of coils 22 are formed using semiconductor process technology on the insulating substrate 21. Therefore, in a coil structure 20, the initially formed multiple layers of coils 22 are separated from each other and completely insulated. In this way, when the adjacent two layers of coils 22 are formed, it is necessary to drill holes at the positions of the first connection end 221 and the second connection end 222 between the adjacent two layers of coils 22 and sink conductors into the holes, that is, to form conductive vias (commonly known as conductive through-hole), so that the two first connection ends 221 or the two second connection ends 222 between the adjacent two layers of coils 22 are electrically connected, and ultimately the multiple layers of coils 22 are arranged in series. Due to the overlapping projections of the first connection end 221 and the second connection end 222 of the multi-layer coil 22 along the radial direction of the cylindrical structure 10 on the insulating substrate 21, the accuracy of the drilling holes is greatly improved, thereby greatly improving product yield and reducing manufacturing costs.

In the process of forming each layer of coils 22 using semiconductor process technology, the wire of each layer of the coils 22 is prepared and formed through additive manufacturing technology. When forming the first layer of the coil 22 on the insulating substrate 21, a layer of photoresist is coated on the surface of the insulating substrate 21, and then the coil 22 is projected onto the photoresist. Through laser engraving, UV etching (ultraviolet etching), and other steps, a sink groove in the shape of a coil of the coil 22 is formed on the insulating substrate 21, and a layer of seed copper is sputtered into the sink groove through the sputtering process. Then, through an electroplating process, additive manufacturing is performed on the seed copper to form the coil circuit (copper wire) of the coil 22, wherein the combination of sputtering process and electroplating process is called additive process. Moreover, in the coil structure 20 of the slotless brushless motor stator in the embodiments of the present disclosure, the cross-sectional shape of the wires of each layer of coils 22 is rectangular, trapezoidal, or curved at the top (such as a bread section). That is to say, when the additive manufactured coil just fills the sink groove and the cross-sectional shape of the sink groove is rectangular or trapezoidal, the cross-sectional shape of the wires of the coil 22 is the same as that of the sink groove, which is rectangular or trapezoidal. When the circuit manufactured by additive manufacturing does not fill the sink groove or slightly exceeds the groove, the top of the wires of the coil 22 forms an arc shape during the additive manufacturing process, that is, the top of the cross-section of the wires forms an arc shape. After the first layer coil 22 is formed, the second layer coil 22 is continuously formed, and the forming process is the same as that of the first layer coil 22. The layer of photoresist coated on the first layer coil 22 is the insulation layer between adjacent layers of the coil 22. Repeat the process in sequence to prepare and form a laminated multi-layer coil section 22.

Moreover, when semiconductor process technology is used to form each layer of coils 22 on the insulating substrate 21, the insulating substrate 21 is in a flat state, that is, each layer of coils 22 is formed on a plane. This not only reduces the difficulty of forming each layer of coils 22 using semiconductor process technology, but also greatly reduces the difficulty of drilling holes, and improves the accuracy of the electrical connection between the two first connection ends 221 or the two second connection ends 222 between adjacent layers of coils 22. After preparing a plurality of coil structures 20, each coil structure 20 is bent into an arc shape with a predetermined arc angle, so that a plurality of the coil structures 20 are arranged around the circumference to form a cylindrical structure 10. Moreover, the outer wall of the cylindrical structure 10 is covered with an insulating protective film, which can not only protect the outer wall of the cylindrical structure 10 from being damaged when the cylindrical structure 10 is moved, but also make the cylindrical structure 10 basically shaped to prevent the plurality of coil structures 20 of the cylindrical structure 10 from loosening and detaching.

In some embodiments of the slotless brushless motor stator 100 of the present disclosure, each coil structure 20 includes n layers of coils 22, and n≥2m, where m is a positive integer. That is to say, the number of layers of the coil 22 of the coil structure 20 of the slotless brushless motor stator 100 can be an even number of layers such as 2, 4, 6, 8, 10, etc. In each coil structure 20, when the a plurality of coils 22 are arranged in series, the first connection end 221 of the first layer coil 22 is set as one of the positive terminal (i.e., the first connection end 221 of the first layer coil 22 is connected to the positive electrode pad 41 as the positive terminal) and the negative terminal (i.e., the first connection end 221 of the first layer coil 22 is connected to the negative electrode pad 42 as the negative terminal) of the coil structure 20 radially outward along the axis of the slotless brushless motor stator 100 of the cylindrical structure 10. The first connection end 221 of the outermost layer coil 22 is set as the other one of the positive terminal and the negative terminal of the coil structure 20. In this disclosure, the first connection end 221 of the first layer coil 22 is connected to the positive electrode pad 41 as the positive terminal, and the first connection end 221 of the outermost layer coil 22 is connected to the negative electrode pad 42 as an example for explanation. In this way, the positive electrode pad 41 of the coil structure 20 can be directly electrically connected to the first connection end 221 of the first layer coil 22 by a lead wire, while the negative electrode pad 42 of the coil structure 20 can also be directly electrically connected to the first connection end 221 of the outermost layer coil 22 by a lead wire. The lead wire between the first connection end 221 of the first layer coil 22 and the positive electrode pad 41, as well as the lead wire between the first connection end 221 of the outermost layer coil 22 and the negative electrode pad 42, are located on the same side of the insulating substrate 21, optimizing the wiring design of the coil structure 20 and reducing wiring difficulty.

Preferably, in the slotless brushless motor stator 100 of the embodiment of the present disclosure, each coil structure 20 includes four layers of coils 22 (i.e., m=2).

In other embodiments of the slotless brushless motor stator 100 of the present disclosure, the number of layers of the coil 22 of each coil structure 20 may also be odd layers, such as 1, 3, 5, 7, 9, etc. At this time, in each coil structure 20, when the multiple layers of coils 22 are arranged in series, the first connection end 221 of the first layer coil 22 is set as one of the positive terminal or negative terminal of the coil structure 20 radially outward along the axis of the slotless brushless motor stator 100 of the cylindrical structure 10, and the second connection end 222 of the outermost layer coil 22 is set as the other of the positive terminal and negative terminal of the coil structure 20 (taking the example of the first connection end 221 of the first layer coil 22 being set as the positive terminal of the coil structure 20 and the second connection end 222 of the outermost layer coil 22 being set as the negative terminal of the coil structure 20). In this embodiment, the positive electrode pad 41 of the coil structure 20 can be directly connected to the first connection end 221 of the first layer coil 22 through a lead wire. However, when connecting the second connection end 222 of the outermost coil 22 to the negative electrode pad 42 through a lead wire, a hole needs to be drilled at the second connection terminal 222 of the outermost coil section 22 to allow it to pass through the insulating substrate 21, then the conductor are placed into the hole, and then the lead wire is connected to the negative electrode pad 42 on the other side of the insulating substrate 21 away from the coil 22. That is to say, the lead wire between the first connection end 221 of the first layer coil 22 and the positive electrode pad 41, as well as the lead wire between the second connection end 222 of the outermost layer coil 22 and the negative electrode pad 42 are located on both sides of the insulating substrate 21, respectively.

In some embodiments of the slotless brushless motor stator of the present disclosure, the shape of each spiral coil of each layer of coils 22 along the axial direction of the slotless brushless motor stator is rectangle, rhombus, polygon, rounded rectangle, or olive-shaped, wherein the polygon includes hexagons and polygons with more sides, preferably regular polygons.

In some embodiments of the slotless brushless motor stator of the present disclosure, the wire width of each layer of coils 22 of the coil structure 20 in the wiring direction is set to be variable. That is to say, while keeping the total resistance of each layer of coils 22 basically unchanged, the wire width of each layer of coils 22 can be increased or decreased at any position to meet the actual wiring requirements. Moreover, within the same coil structure 20, the number of turns of any two layers of coils 22 can be equal or unequal. In the present embodiment of the present disclosure, it is preferable that the number of coil turns of any two layers of coils 22 is equal within the same coil structure 20.

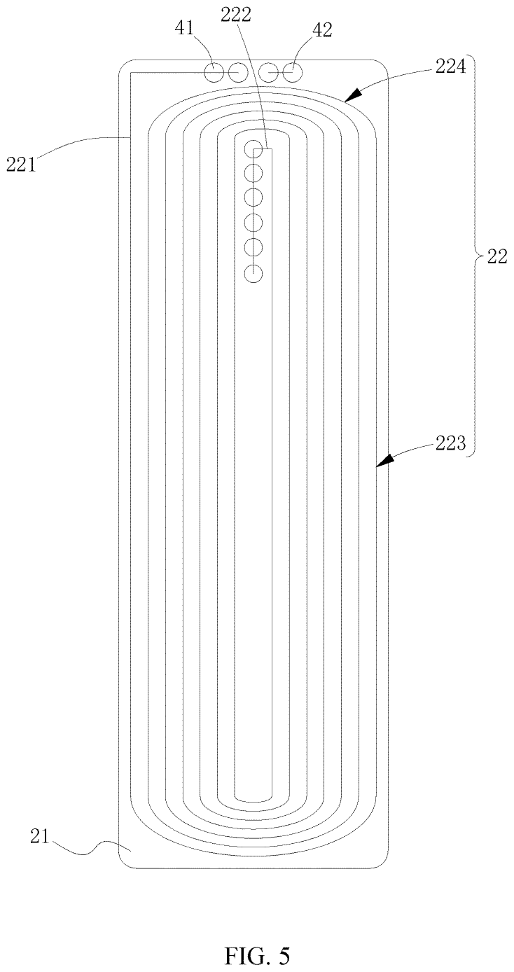

As shown in FIG. 5 to FIG. 7, in some embodiments of the present disclosure, when the shape of each coil of each layer of coils 22 is in the shape of rounded rectangle, the insulating substrate 21 of each coil structure 20 is square along the axial direction of the slotless brushless motor stator 100. In each coil structure 20, each layer of coils 22 includes multiple straight sections 223 along the length direction of the insulating substrate 21 and multiple variable diameter sections 224 located at both ends of the insulating substrate 21, wherein the length direction of the insulating substrate 21 is parallel to the axial direction of the slotless brushless motor stator 100. When the coils 22 of each layer of the coil structure 20 are energized to generate a magnetic field, the effective magnetic field range is not the entire magnetic field range generated by the coils 22, but mainly the magnetic field range generated by multiple straight sections 223. The magnetic field range generated by multiple variable diameter sections 224 located at both ends of the insulating substrate 21 has a relatively minor effect on the magnetic induction of the rotor assembly 230 compared to the magnetic field range generated by multiple straight sections 223. In the slotless brushless motor stator 100, the lengths of multiple straight sections 223 are equal in each layer of coils 22 of each coil structure 20. As a result, the range of effective magnetic fields generated when each layer of coils 22 is energized increases. When the slotless brushless motor stator 100 is assembled with the brushless slotless motor 200, the effective magnetic field range acting on the rotor assembly 230 of the brushless slotless motor 200 increases, effectively improving the output efficiency of the brushless slotless motor 200 and enhancing the product quality of the brushless slotless motor 200.

The wire width of the straight section 223 is greater than, equal to, or less than the wire width of the variable diameter section 224. In order to further improve the magnetic field range generated by multiple straight sections 223 on the magnetic induction effect of the rotor assembly 230, it is preferred in the present disclosure that the wire width of straight section 223 is greater than that of variable diameter section 224. This enables the maximum design of the length of multiple straight section 223 on the insulating substrate 21, that is, increasing the length of multiple straight sections 223, and reducing the length of the area occupied by the variable diameter section 224 at the end position of the insulating substrate 21, so that the magnetic field range generated by multiple straight sections 223 approaches the maximum magnetic induction effect on the rotor assembly 230.

Moreover, although the length of the straight section 223 with a wider wire width has increased, the length of the variable diameter section 224 will correspondingly decrease, Further, the wire width of the variable diameter section 224 is smaller than that of the straight section 223, such that the resistance of each layer of coils 22 can be kept constant. In this way, the heat generation of each layer of coils 22 will not increase. This is beneficial for ensuring the overall thermal performance of the slotless brushless motor stator 100, ensuring the effective working time of the slotless brushless motor stator 100, and extending the service life of the slotless brushless motor stator 100.

Furthermore, when the wire width of the variable diameter section 224 is smaller than that of the straight section 223, the height of the multiple of variable diameter sections 224 located at both ends of the insulating substrate 21 along the length direction of the insulating substrate 21 can be effectively reduced during spiral wiring of the coils 22 in each layer. This is beneficial for reducing the overall length of the coil structure 20 along the axial direction of the slotless brushless motor stator 100.

In some embodiments of the present disclosure, the wire thickness of any two layers of coils 22 in the same coil structure 20 may be equal or unequal.

When the wire thickness of any two layers of coils 22 in the same coil structure 20 is not equal, in some embodiments of the slotless brushless motor stator 100 of the present disclosure, the wire thickness of the multiple layers of coils 22 of each coil structure 20 gradually increases radially outward from the axis of the cylindrical structure 10. That is to say, in the multiple layers of coils 22 of each coil structure 20, in the radial direction outward from the axis of the cylindrical structure 10, the closer to the axis of the cylindrical structure 10, the higher the coil density of the coil 22. This can effectively enhance the magnetic induction effect of the magnetic field generated by the coil 22 on the rotor assembly 230 of the brushless slotless motor 200, thereby improving the output power and torque of the brushless slotless motor 200. Moreover, the design structure in which the wire thickness of the multiple layers of coils 22 of each coil structure 20 gradually increases can maintain the resistance of each layer of coils 22 unchanged, so that the heat generation of each layer of coils 22 does not increase. In such way, it is conductive to improve the overall thermal performance of the slotless brushless motor stator 100, ensuring its effective working time, and extending its service life.

In some embodiments of the present disclosure, the cylindrical structure 10 is composed of multiple layers of cylinders sequentially nested, and the number of multiple coil structures 20 in each layer of cylinders is equal. Moreover, along the radial direction of the cylindrical structure 10, multiple coil structures 20 are arranged in a one-to-one correspondence between two adjacent layers of cylinders. In the multiphase motor of this embodiment, such as a three-phase motor, each layer of the cylinders is surrounded by three coil structures 20 in the radial direction, and each phase is composed of multiple coil structures 20 along the radial direction of the cylindrical structure 10. This increases the number of winding turns of each phase, thereby increasing the magnetic field strength generated, effectively enhancing the magnetic induction effect of the magnetic field generated by the coil 22 on the rotor assembly 230 of the brushless slotless motor 200, and improving the output power and torque of the brushless slotless motor 200.

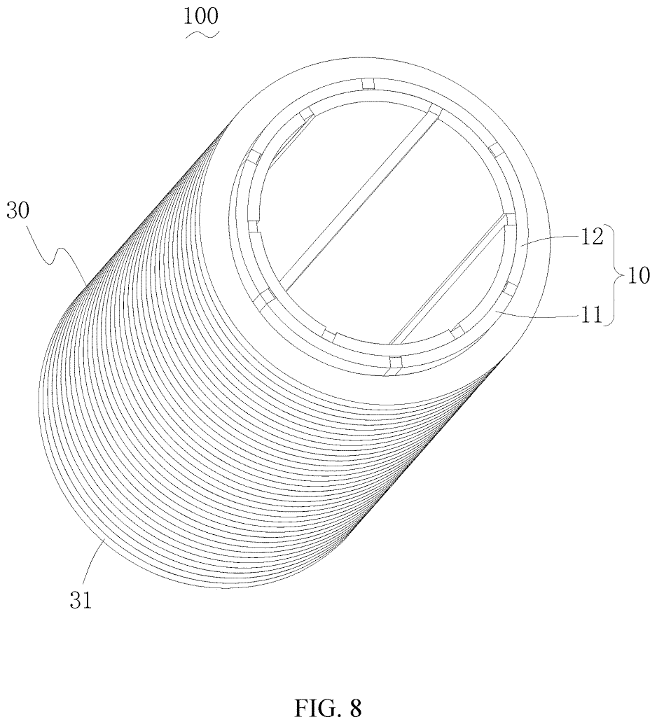

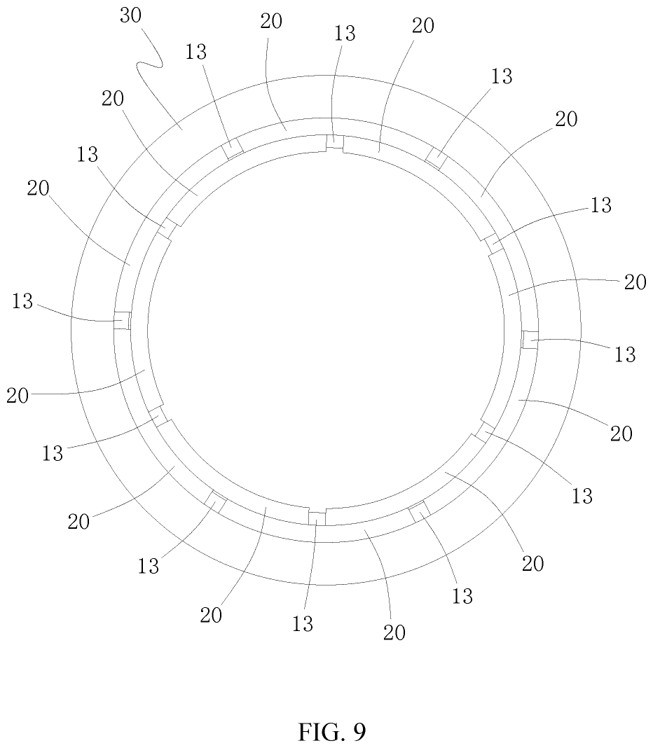

In some embodiments of the present disclosure, the cylindrical structure 10 is composed of multiple layers of cylinders sequentially nested, and the number of multiple coil structures 20 in each layer of cylinders is equal. Moreover, multiple coil structures 20 between any two adjacent layers of cylinders are displaced by a predetermined angle in the same circumferential direction. As shown in FIG. 8 and FIG. 9, in some embodiments of the present disclosure, the cylindrical structure 10 includes an inner cylinder 11 and an outer cylinder 12 nested on the inner cylinder 11, that is, the cylindrical structure 10 is composed of two layers of nested cylinders. The number of multiple coil structures 20 in the inner cylinder 11 is equal to that in the outer cylinder 12, and two adjacent coil structures 20 are connected by a connection part 13. The multiple coil structures 20 in the inner cylinder 11 and the outer cylinder 12 are arranged in a staggered manner along the circumference. For example, if each layer of the cylinder is surrounded by three coil structures 20 in the circumferential direction, then the central angle corresponding to each coil structure 20 is 120°. In such way, the predetermined rotation angle set by the outer cylinder 12 relative to the inner cylinder 11 in the circumferential direction is 60°. Thus, the cylindrical structure 10 formed by the inner cylinder 11 and the outer cylinder 12 actually has six phases.

In the slotless brushless motor stator 100 of the present disclosure, the number of coil structures 20 of the cylindrical structure 10 can be 3, 6, 9, 12, etc., which is an integer multiple of 3 coil structures 20. And these coil structures 20 are divided into multiple parts, each part is surrounded to form a layer of cylinder, and then multiple layers of cylinder are sequentially nested to form a cylindrical structure 10.

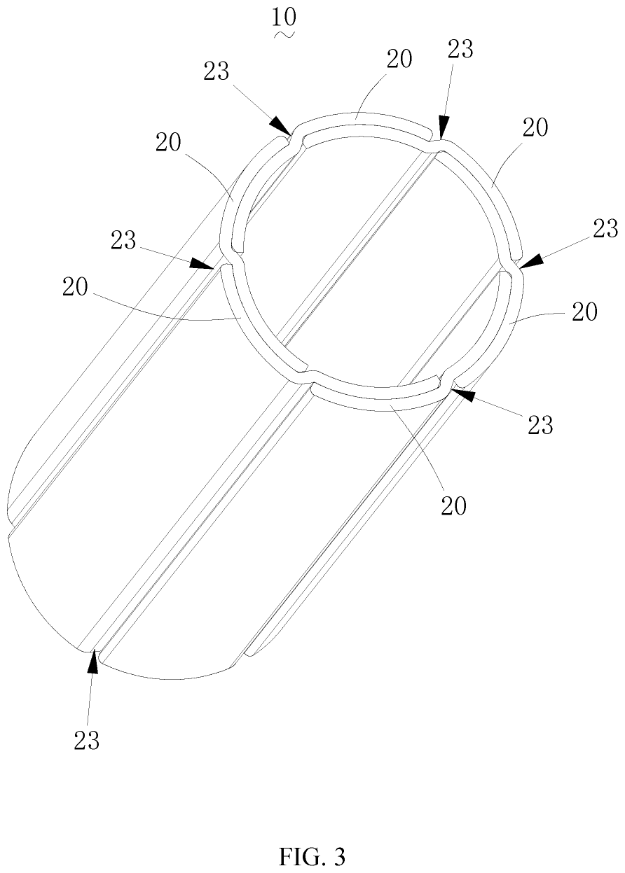

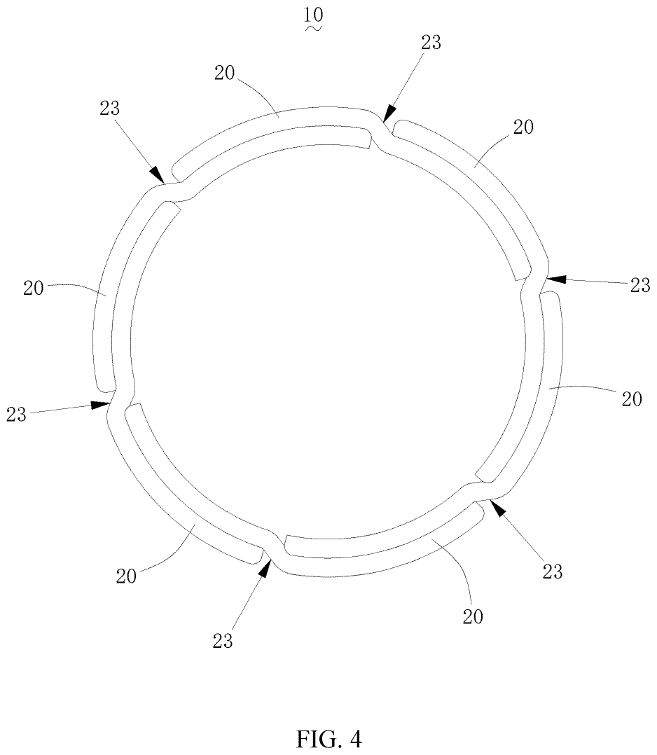

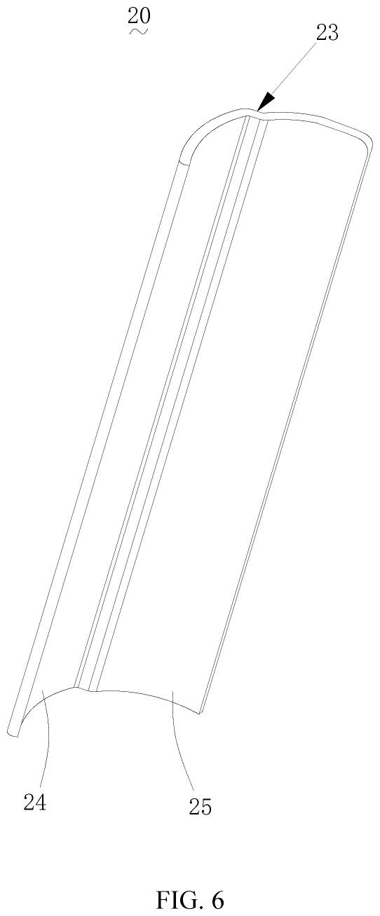

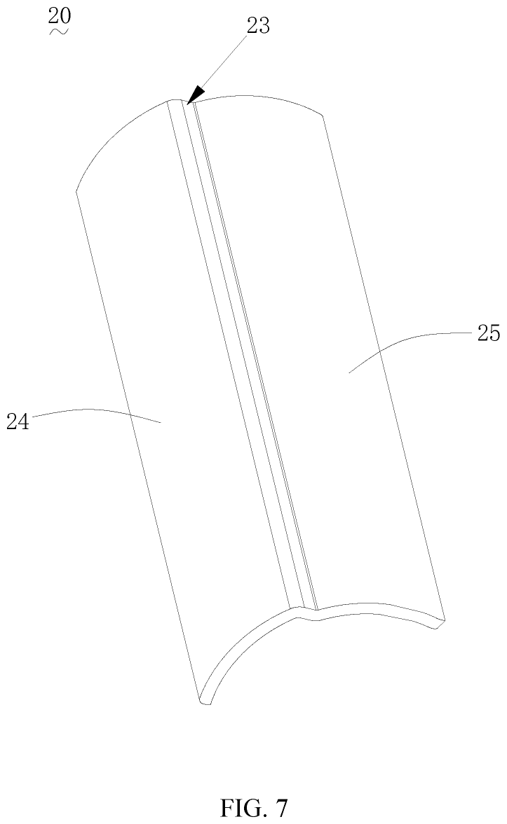

In some embodiments of the present disclosure, as shown in FIG. 6 and FIG. 7, the coil structure 20 is provided with a stepped edge 23. Along the radial direction of the cylindrical structure 10, the stepped edge 23 forms a first coil portion 24 and a second coil portion 25 with a height difference in the coil structure 20, and the height of the stepped edge 23 is equal to the thickness of the coil structure 20. As shown in FIG. 3 and FIG. 4, in two adjacent coil structures 20 along the circumference of the cylindrical structure 10, the first coil portion 24 of one coil structure 20 is stacked with the second coil portion 25 of the other coil structure 20, and multiple coil structures 20 are connected end-to-end to form the cylindrical structure 10. In the multiphase motor of this embodiment, multiple coil structures 20 are interlocked and connected end-to-end through stepped edges 23, forming two layers of cylinders. This makes the cylindrical structure 10 formed by the multiple coil structures 20 along the circumference more stable.

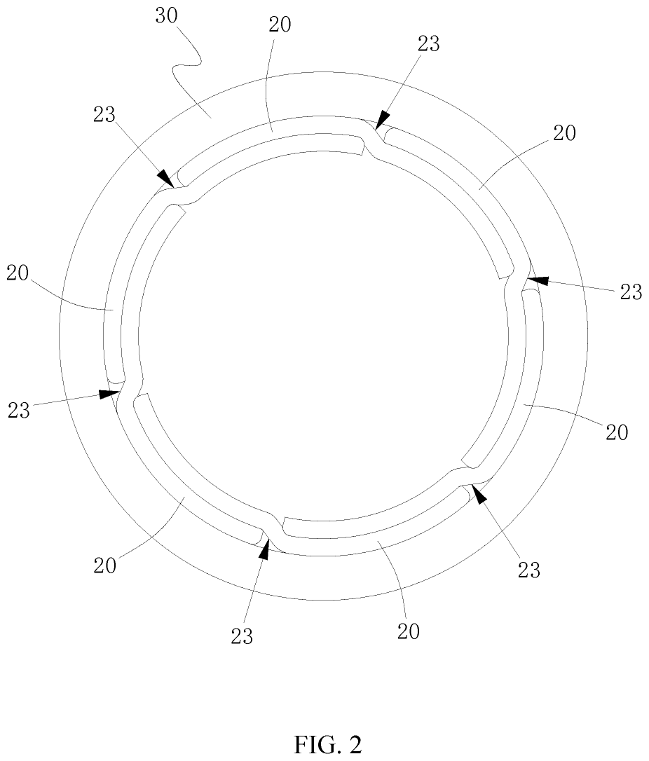

As shown in FIG. 1 and FIG. 2, in some embodiments of the present disclosure, the slotless brushless motor stator 100 further includes an iron core tube 30, which is fixed outside the cylindrical structure 10. The iron core tube 30 can effectively guide and concentrate the magnetic field to form a magnetic circuit, improve electromagnetic performance, and efficiently generate and transmit electromagnetic energy. In addition, the iron core tube 30 is configured to provide mechanical support for the cylindrical structure 10, withstand the electromagnetic and mechanical forces generated during the operation of the brushless slotless motor 200, and prevent damage to the cylindrical structure 10 due to vibration or impact. Moreover, by providing the iron core cylinder 30 outside the cylindrical structure 10, it is beneficial for heat dissipation of the cylindrical structure 10 and can effectively reduce the temperature rise of the brushless slotless motor 200 during operation. The iron core tube 30 includes a plurality of magnetic material sheets 31, and the plurality of magnetic material sheets 31 are sequentially stacked and formed along the axial direction of the slotless brushless motor stator 100, and are insulated between two adjacent magnetic material sheets 31. The iron core tube 30 formed by stacking the plurality of magnetic material sheets 31 can reduce eddy current losses and hysteresis losses when a magnetic field is generated by energizing the coil 22 of the coil structure 20. The magnetic material sheet 31 includes but is not limited to silicon steel sheet, non-crystalwire material sheet, iron sheet, etc.

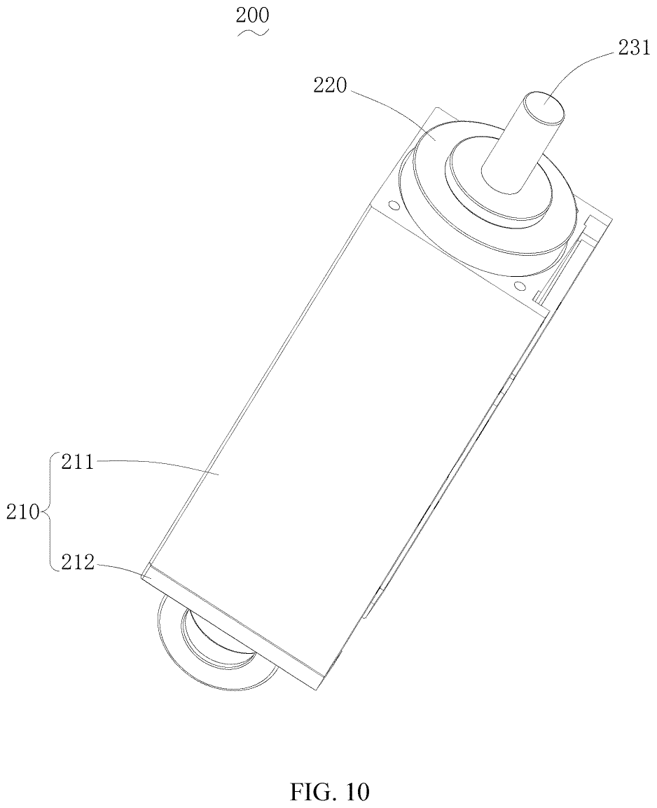

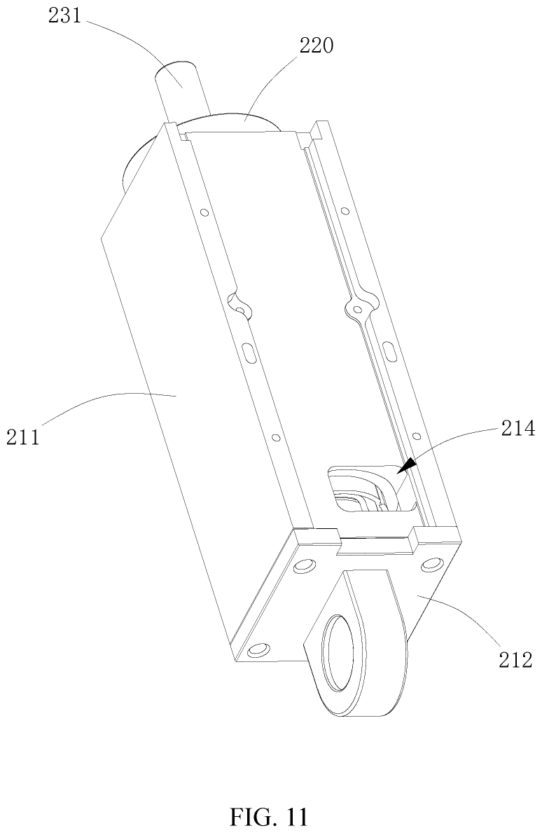

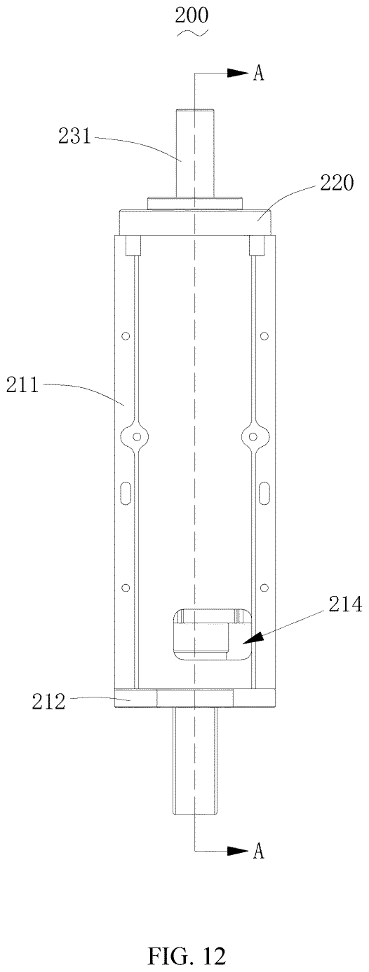

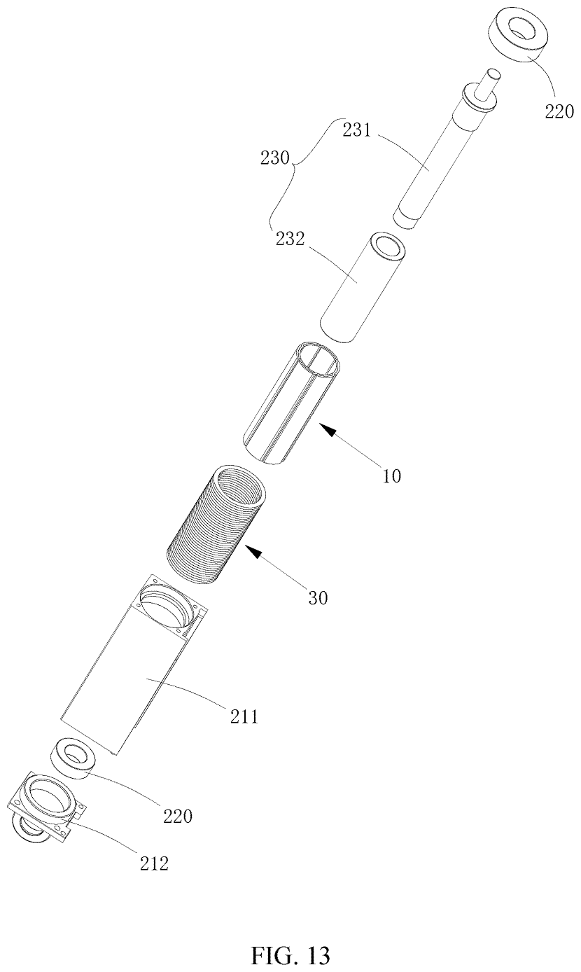

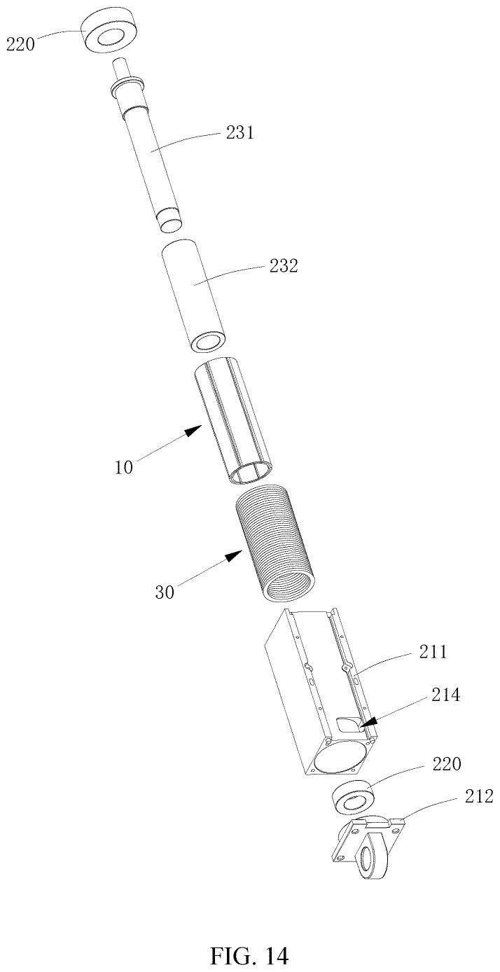

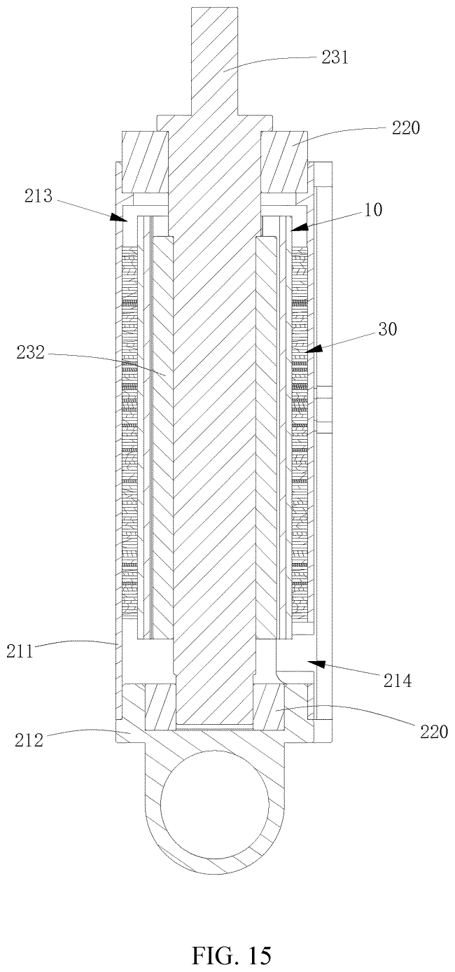

According to another aspect of the present disclosure, a brushless slotless motor 200 is provided. As shown in FIG. 10 to FIG. 15, the brushless slotless motor 200 includes a shell 210, a rotor assembly 230, two bearings 220, and the aforementioned slotless brushless motor stator 100. The shell 210 includes a shell body 211 and an end cover 212. The end cover 212 covers one end of the shell body 211 to form an assembly space 213, and the slotless brushless motor stator 100 is accommodated in the assembly space 213. In addition, the wires led out from the positive electrode pad 41 and the negative electrode pad 42 of each coil structure 20 pass through the outlet 214 of the shell 210, and the led out wires are used for electrical connection to the electronic commutation mechanism. Moreover, as shown in FIG. 13 to FIG. 15, the two bearings 220 are installed on the shell 210, and the two bearings 220 are located at both ends of the slotless brushless motor stator 100, that is, one bearing 220 is installed on the end cover 212, and the other bearing 220 is installed on the other end of the shell body 211 away from the end cover. As shown in FIG. 13 to FIG. 15, the rotor assembly 230 includes a core shaft 231 and a permanent magnet 232. The permanent magnet 232 is fixedly mounted on the core shaft 231 and is rotatably passed through the slotless brushless motor stator 100. The two ends of the core shaft 231 are respectively mounted on two bearings 220, and at least one end of the core shaft 231 serves as the motor output end. The motor output end can be the end of the core shaft 231 that penetrates through the shell 210, alternatively, the motor output end can also be located inside the shell 210. One end of the core shaft 231 penetrates through and extends out of the end of the shell body 211 away from the end cover 212, serving as the single output end of the motor, at this point, the motor is a single-head motor. Alternatively, one end of the core shaft 231 penetrates through and extends out of the end of the shell body 211 away from the end cover 212 as one of the output ends, and the other end of the core shaft 231 extends out of the end cover 212 as the other output end, in this case, the motor is a double-ended motor.

The above description is only the preferred embodiment of the present disclosure and is not intended to limit the present disclosure. Any modifications, equivalent substitutions, and improvements made within the spirit and principles of the present disclosure should be included within the scope of the present disclosure.

What is claimed is:

1. A slotless brushless motor stator, comprising a plurality of coil structures arranged along circumference to form a cylindrical structure;
wherein each coil structure comprises an insulating substrate and multiple layers of coils stacked on the insulating substrate, each coil structure comprises n layers of coils, and n≥2m, where m is a positive integer, at least one wire arranged in a spiral shape to form each layer of the coils, and each layer of the coils includes a first connection end and a second connection end;
the first connection end is a spiral outer end of each layer of the coils, and the second connection end is a spiral inner end of each layer of the coils, and spiral directions of two adjacent layers of the coils from the first connection end to the second connection end are opposite;
in the radial direction outward along an axis of the cylindrical structure, the first connection end of a first layer of the coils is set as one of a positive terminal and a negative terminal of each coil structure, and the first connection end or the second connection end of an outermost layer of the coils is set as another of the positive terminal and the negative terminal of each coil structure; between two adjacent layers of the coils, two of the first connection ends or two of the second connection ends are electrically connected, so that the multiple layers of the coils are arranged in series, and an insulation layer is provided between two adjacent layers of the coils.

2. The slotless brushless motor stator according to claim 1, wherein in each coil structure, along the radial direction of the cylindrical structure, projections of the first connection end and the second connection end of each layer of the coils on the insulating substrate coincide.

3. The slotless brushless motor stator according to claim 1, wherein at least one wire of each layer of the coils is prepared and formed through additive manufacturing, and a cross-section of at least one wire is rectangular, trapezoidal, or curved at a top.

4. The slotless brushless motor stator according to claim 1, wherein along an axial direction of the cylindrical structure, a shape of each layer of the coils is rectangle, rhombus, polygon, rounded rectangle, or olive-shaped.

5. The slotless brushless motor stator according to claim 4, wherein at least one wire of each layer of the coils has a variable width in a wiring direction, and in the same coil structure, the number of turns of any two layers of the coils is equal or unequal.

6. The slotless brushless motor stator according to claim 5, wherein when the shape of each layer of the coils is rounded rectangle, the insulating substrate is square, at least one wire that forms each layer of the coils comprises multiple straight sections along a length direction of the insulating substrate and multiple variable diameter sections located at both ends of the insulating substrate; lengths of the multiple straight sections are equal, and the wire width of the straight sections is greater than, equal to, or less than the wire width of the variable diameter sections.

7. The slotless brushless motor stator according to claim 4, wherein the wire thickness of at least one wire in any two layers of the coils is equal or unequal in the same coil structure.

8. The slotless brushless motor stator according to claim 7, wherein the wire thickness of the multiple layers of the coils of each coil structure gradually increases radially outward along the axis of the cylindrical structure.

9. The slotless brushless motor stator according to claim 1, wherein the slotless brushless motor stator further comprises an iron core tube, the iron core tube is sleeved and fixed outside the cylindrical structure, and the iron core tube is formed by stacking a plurality of ring-shaped magnetic material sheets.

10. The slotless brushless motor stator according to claim 1, wherein:
the cylindrical structure consists of multiple layers of cylinders arranged in sequence, with an equal number of multiple of the coil structures in each layer;
along the radial direction of the cylindrical structure, the multiple of the coil structures between two adjacent layers of the cylinders are arranged in a one-to-one correspondence and face each other directly, or the multiple of the coil structures between any two adjacent layers of the cylinders are circumferentially offset by a predetermined angle in the same direction.

11. The slotless brushless motor stator according to claim 1, wherein:
each coil structure is provided with stepped edges, along the radial direction of the cylindrical structure, each stepped edge allows each coil structure to form a first coil portion and a second coil portion with a height difference, and a height of each stepped edge is equal to a thickness of each coil structure; in two adjacent coil structures along a circumference of the cylindrical structure, the first coil portion of one coil structure is stacked with the second coil portion of the other coil structure, and the multiple of the coil structures are connected end-to-end to form the cylindrical structure.

12. A brushless slotless motor, comprising:
a shell provided with assembly space;
a slotless brushless motor stator according to claim 1, wherein the slotless brushless motor stator is accommodated in the assembly space;
two bearings installed on the shell, wherein the two bearings are respectively located at both ends of the slotless brushless motor stator;
a rotor assembly rotatably installed in the slotless brushless motor stator, wherein two ends of the rotor assembly are respectively mounted on the two bearings.
